(19) United States
(12) Patent Application Publication
(10) Pub. No.: US 2004/0159048 A1
(43) Pub. Date: Aug. 19, 2004

(54) Self-aligning top guide wheel for sliding doors

(75) Inventor: Kenneth Jacobs, Guildford (GB)

Correspondence Address: PILLSBURY WINTHROP, LLP, P.O. BOX 10500, MCLEAN, VA, 22102, US

(73) Assignee: THE STANLEY WORKS, New Britain, CT (US)

(21) Appl. No.: 10/771,543

(22) Filed: Feb. 5, 2004

Related U.S. Application Data
(60) Provisional application No. 60/447,331, filed on Feb. 14, 2003.

(51) Int. Cl. E05D 13/00

(52) U.S. Cl. 49/425

(57) ABSTRACT

A wheel guide assembly is disclosed for mounting an upper portion of a door with respect to a track. The wheel guide assembly includes a mounting structure, at least one axle disposed on the mounting structure, and at least one wheel. The axle has a longitudinal axis and includes a central portion that is non-cylindrical in shape. The wheel rotates about an axis of rotation and is rotatably mounted to the axle such that the wheel does not always rotate about the longitudinal axis of the axle.

The present application claims priority to U.S. Provisional Application No. 60/447,331, filed Feb. 14, 2003, the entirety of which is hereby incorporated into the present application by reference.

### BACKGROUND OF THE INVENTION

1. Field of the Invention

The present invention relates generally to sliding doors, and more specifically to a top wheel guide for sliding doors. The top wheel guide has a range of movement that permits the sliding of a door that may be misaligned or out of vertical.

2. Description of Related Art

Sliding panel doors, such as those used in closets, are constructed from thin panels that gain rigidly from the application of a perimeter frame formed by two side, one top, and one bottom roll formed or extruded metal sections that are mechanically joined at each corner by means of a metal or plastic joining plate. The weight of the panel door is typically supported by a bottom track, and the door is provided with wheels or other slidable elements that can slide or roll within the bottom track. The panels may be formed of wood.

The top portion of the door is often retained and guided in a top “E” section track which provides downwardly depending leg portions defining vertical surfaces in which the upper portion of the panel door is retained and guided. Particularly, the upper portion of the panel door is typically provided by a top wheel guide assembly that is attached to the metal or plastic frame joining plate at each top corner of the door. The top wheel guide assembly typically includes a pair of axles and a pair of wheels, or rollers. Each wheel or roller is rotatably mounted to an axle such that the wheels rotate about a common vertical axis with the axle.

To accommodate tolerance variation in the width of the track section between the vertical parallel track surfaces, one or more of the two wheels is typically retained on an outwardly spring biased axle to produce a snug fit and eliminate transverse movement and rattle of the door with respect to the track. Typically, the top wheel guide assembly is formed from several components, such as a metal or plastic bracket, and a spring bias axle assembly which is a separate component mounted to the bracket. In addition, other attachments are provided for connecting the top guide to the door assembly.

As the door travels along the lower and upper tracks, the top wheel guide wheels or rollers rotate against the inside parallel vertical edges of the E track and maintain a door positioned centrally within the track cavity. However, if the door is adjusted out of vertical, for example, to align the door with a non-vertical side frame or door jam, the wheel no longer runs vertically against the track wall and will cause the door to shake or vibrate as the wheel attempts to correct the misalignment. The door becomes difficult to move and the vibration causes undesirable noises. Furthermore, it is possible that the door may dislodge from the tracks.

### SUMMARY OF THE INVENTION

It is an object of the present invention, therefore, to provide a top wheel guide assembly that can tolerate a door that is misaligned such that the door continues to slide easily, smoothly, and quietly. Accordingly, the present invention provides a top wheel guide assembly that includes a mounting structure with one end of a top portion that is disposed at one end of a body portion, at least one axle disposed on the top portion, and at least one wheel. The axle includes a longitudinal axis and the wheel includes an axis of rotation. The wheel is rotatably mounted to the axle such that the longitudinal axis of the axle is not always the same as the axis of rotation of the wheel. The axle can pivot with respect to the wheel such that the wheel maintains proper alignment within the track.

It is a further object of the present invention to provide a top wheel guide assembly that includes a mounting structure with one end of a top portion that is disposed at one end of a body portion, at least one axle disposed on the top portion and at least one wheel. The axle includes a central portion that is non-cylindrical in shape. The wheel includes a plurality of fingers that engage the non-cylindrical portion of the axle such that the wheel is mounted on the axle, but can still rotate on its own substantially vertical axis, even when the door is not vertical.

It is a further object of the present invention to provide a wheel assembly for a sliding door that includes a wheel with a central portion that includes a plurality of flexible fingers and an axle with a non-cylindrical central portion. The plurality of flexible fingers engage the axle such that the wheel is rotatably mounted on the axle and can pivot on the axle. Pivoting of the axle with respect to the wheel does not impart rotation of the wheel.

Other objects, advantages, and features of the present invention will be appreciated from the following detailed description, drawings, and claims.

### BRIEF DESCRIPTION OF THE DRAWINGS

The invention will be described in conjunction with the following drawings in which like reference numerals designate like elements and wherein:

FIG. 1 is a perspective view of a top “E” section track and a top wheel guide assembly within the track;

FIG. 2 is a side view of the track and assembly of FIG. 1;

FIG. 3 is an exploded view of a wheel and an axle of the present invention;

FIG. 4 is a cross-sectional view of the wheel and axle of FIG. 3; and

FIG. 5 is a cross-sectional view of the wheel and axle of FIG. 3 in an assembled position.

### DETAILED DESCRIPTION OF THE PREFERRED EMBODIMENTS

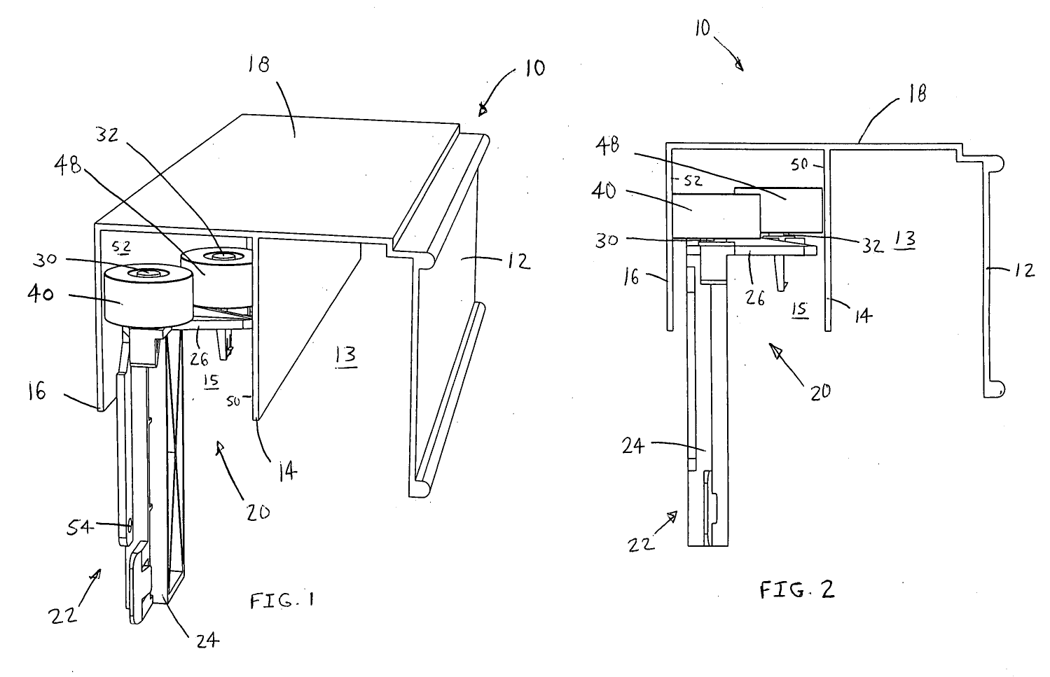

FIG. 1 is a perspective view of a top “E” section track 10 and a top wheel guide assembly 20 of the present invention. The track 10 has three downwardly depending flanges 12, 14, and 16. Flanges 14 and 16 define a channel 15 therebetween which receives the top wheel guide assembly 20 associated with one door. Flanges 12, 14, and 16 are interconnected by an upper web portion 18. It can be appreciated that a second top wheel guide assembly associated with another door (not shown) can be received in a channel 13 between flanges 12 and 14. Flanges 14 and 16 define vertically disposed opposing parallel track surfaces 50 and 52 respectively.

The top wheel guide assembly 20 includes a mounting structure 22 for being mounted to an upper portion of the door, and first and second wheels 40, 48 which are mounted for rotational movement on the mounting structure 22. The mounting structure 22 of the top wheel guide assembly 20 mounts the wheels 40, 48 of the wheel guide assembly 20 in rolling engagement with respect to the track 10. Preferably, the wheels 40, 48 are mounted such that they overlap when looking down the channel 15 (illustrated in FIG. 2), such that each wheel contacts an opposite wall 14, 16 of the channel 15. As shown in FIGS. 1 and 2, the first wheel 40 is in rolling engagement with parallel track surface 52 and the second wheel 48 is in rolling engagement with parallel track surface 50.

The mounting structure 22 includes a body portion 24 and a top portion 26. One end of the top portion 26 is disposed at one end of the body portion 24 such that the two portions 24, 26 generally form a right angle. This allows the top wheel guide assembly 20 to be supported by the top of the door and a side of the door. The mounting structure 22 can be fabricated from any suitable material, including but not limited to metal and plastic. Preferably, the entire mounting structure 22 is manufactured from a single injection molded plastic material. Any suitable plastic material can be used.

The mounting structure 22 may be of a detailed design and mounted to the door by way of systems described in commonly assigned U.S. Pat. Nos. 5,349,783, 5,974,738, and 6,449,906 B1, which are hereby incorporated by reference into the present application in their entirety. It is recognized that the mounting structure 22 is not limited to the designs disclosed in the above referenced patents and that the mounting structure 22 may also include slots and/or holes 54 such that fasteners, such as screws and the like, may be used to attach the mounting structure 22 directly to the door.

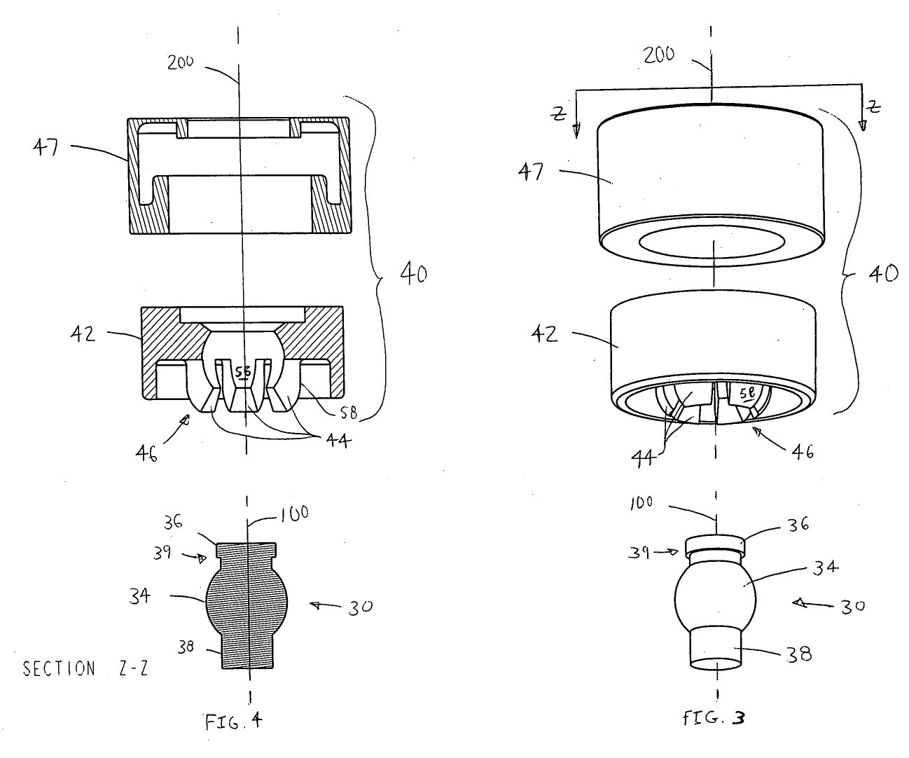

The top wheel guide assembly 20 further includes at least one axle. In the preferred embodiment, a first axle 30 and a second axle 32 are disposed on the top portion 26 of the mounting structure 22. Preferably, the axles 30, 32 are disposed on an angle relative to the channel 15, as illustrated in FIGS. 1 and 2. Each axle 30, 32 has a longitudinal axis 100 that is substantially perpendicular to the top portion 26 of the mounting structure 22, and, hence, to the top of the door. FIGS. 3 and 4 illustrate the first axle 30 in greater detail. It is understood that the second axle 32 may be designed to be substantially similar to the first axle 30.

In the preferred embodiment, the axle 30 includes an inner end 38, an outer end 39, and a central portion 34 that is non-cylindrical in shape. Preferably, the central portion 34 of the axle 30 is an enlarged portion as compared to the other portions of the axle 30. More preferably, the central portion 34 is substantially spherical or ellipsoidal in shape. Most preferably, the central portion 34 is substantially spherical in shape. The inner end 38 of the axle 30 is mounted to the mounting structure 22. Preferably, the axle 30 is molded as an integral part of the mounting structure 22.

The first wheel 40, as illustrated in FIGS. 3 and 4 has an axis of rotation 200 and includes a hub 42 and a tire 47. It is understood that the second wheel 48 may be designed to be substantially similar to the first wheel 40. The wheel 40 is rotatably mounted to the axle 30 by aligning the axis of rotation 200 of the wheel 40 with the longitudinal axis 100 of the axle 30 and then by “snap fitting” the wheel 40 onto the axle 30. This provides a movable connection between the door and the wheel 40, such that the wheel 40 remains aligned in the track 10 even if the door is out of vertical.

The axle 30 and the hub 42 may be of any material or combination of materials that provide for a low coefficient of friction between them so that the wheel 40 may freely rotate about its axis of rotation 200, yet pivot on the axle 30, after the wheel 40 is mounted to the axle 30. This allows the axis of rotation 200 to intersect the longitudinal axis 100 of the axle 30 at an angle greater than zero, but less than 90°.

The axle 30 further includes a collar 36 at the outer end 39 of the axle 30. The collar 36 ensures that the wheel 40 stays mounted to the axle 30 and also limits the pivoting of the wheel 40 relative to the axle 30. Preferably, the collar 36 and hub 42 are designed to allow the axis of rotation 200 to intersect the longitudinal axis 100 of the axle 30 at an angle no greater than about 30°. More preferably, the collar 36 and hub 42 are designed to allow the axis of rotation 200 to intersect the longitudinal axis 100 of the axle 30 at an angle no greater than about 15°.

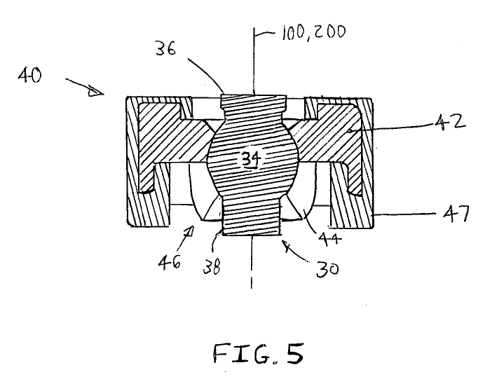

In the preferred embodiment, the hub 42 includes a plurality of fingers 44 disposed at a central portion 46 of the hub 42. Preferably, the fingers 44 are spaced equidistant from the axis of rotation 200 and are defined by an inner side 56 and an outer side 58. The fingers 44 are preferably flexible such that they flex outward in the radial direction as the wheel 40 is mounted to the axle 30 in order for the hub 42 to slide over the non-cylindrical central portion 34 of the axle 30. Once the fingers 44 pass the widest portion of the axle 30, they relax inward in the radial direction such that the lower end of the central portion 34 of the axle 30 is surrounded by the fingers 44 and the inner side 56 of the fingers 44 rest on the inner end 38 of the axle 30. Preferably, the shape of the inner side 56 of the fingers 44, complements the shape of the central portion 34 of the axle 30. FIG. 5 illustrates the wheel 40 and axle 30 of the preferred embodiment in the assembled position. It is understood that the number of, size of, shape of, and spacing between the fingers can be of any combination and still remain in the spirit of this invention.

Alternatively, it is contemplated that the hub may include a non-cylindrical structure that extends along the axis of rotation and the axle may include a plurality of fingers or other suitable structure to receive the non-cylindrical structure of the wheel. This way, the same result is achieved in that the wheel may rotate about its axis of rotation, yet still have the ability to pivot with respect to the axle on which it is mounted.

The tire 47 may be compression fit or insert molded onto the hub 42 such that the tire 47 and hub 42 rotate together about the axis of rotation 200 with minimal or, preferably, no slippage between them. The tire 47 may be fabricated from any suitable material, but is preferably a plastic material that provides a high coefficient of friction when in contact with the track 10, such as polyurethane.

In operation, the top wheel guide assembly 20 is mounted to a door such that the body portion 24 of the mounting structure 22 is substantially vertical and attached to a face of the door and the top portion 26 of the mounting structure 22 is substantially horizontal and attached to the top of the door. The pair of wheels 40, 48 are rotatably mounted to the pair of axles 30, 32 by lining up the axes of rotation 200 of the wheels 40, 48 to the longitudinal axes 100 of the axles 30, 32 and “snap-fitting” the wheels 40, 48 onto the axles 30, 32. The wheels 40, 48 are inserted into the track 10, within channel 15 such that each wheel 40, 48 becomes rotatably engaged with the vertically disposed surfaces 50, 52 of flanges 14, 16, respectively.

If the door is not aligned in the vertical plane, the axes of rotation 200 for the wheels 40, 48 will substantially remain in the vertical plane, such that the wheels 40, 48 remain rotatably engaged with the vertically disposed surfaces 50, 52, while the longitudinal axes 100 of the axles 30, 32 will not lie in the vertical plane. Due to the non-cylindrical central portion 34 of the axles, the wheels 40, 48 can still smoothly rotate about the axles 30, 32, even when the door is not within the vertical plane.

While preferred embodiments of the invention have been shown and described, it is evident that variations and modifications are possible that are within the spirit and scope of the preferred embodiments described herein.

What is claimed is:

1. A wheel guide assembly for a sliding door comprising:
a mounting structure with a body portion and a top portion, wherein one end of the top portion is disposed at one end of the body portion;
at least one axle with a longitudinal axis disposed on the top portion of the mounting structure; and
at least one wheel with an axis of rotation,
wherein the wheel is rotatably mounted to the axle such that the axis of rotation is not always the same as the longitudinal axis.

2. A wheel guide assembly for a sliding door according to claim 1, wherein an angle is formed between the axis of rotation and the longitudinal axis when the wheel and the axle pivot relative to each other.

3. A wheel guide assembly for a sliding door according to claim 2, wherein the angle formed between the axis of rotation and the longitudinal axis is about zero to about 30 degrees.

4. A wheel guide assembly for a sliding door according to claim 3, wherein the angle formed between the axis of rotation and the longitudinal axis is about zero to about 15 degrees.

5. A wheel guide assembly for a sliding door comprising:
a mounting structure with a body portion and a top portion, wherein one end of the top portion is disposed at one end of the body portion;
at least one axle disposed on the top portion of the mounting structure, wherein a central portion of the axle is non-cylindrical in shape;
at least one wheel rotatably mounted to the axle.

6. A wheel guide assembly for a sliding door according to claim 5, wherein the central portion of the axle is an enlarged portion of the axle.

7. A wheel guide assembly for a sliding door according to claim 6, wherein the central portion of the axle is substantially spherical in shape.

8. A wheel guide assembly for a sliding door according to claim 6, wherein the central portion of the axle is substantially ellipsoidal in shape.

9. A wheel guide assembly for a sliding door according to claim 5, wherein a central portion of the wheel includes a plurality of flexible fingers that engage the central portion of the axle.

10. A wheel assembly for a sliding door comprising:
a wheel with a central portion that includes a plurality of flexible fingers; and
an axle with a non-cylindrical central portion,
wherein the plurality of flexible fingers engage the axle such that the wheel is rotatably mounted on the axle and can pivot on the axle.

11. A wheel assembly for a sliding door according to claim 10, wherein the central portion of the axle is an enlarged portion of the axle.

12. A wheel assembly for a sliding door according to claim 11, wherein the central portion of the axle is substantially spherical in shape.

13. A wheel assembly for a sliding door according to claim 11, wherein the central portion of the axle is substantially ellipsoidal in shape.

14. A sliding door assembly comprising:
a door;
a track;
a wheel disposed within the track; and
a movable connection between the door and the wheel, wherein the wheel remains aligned in the track even if the door is out of vertical.
